(19) United States
(12) Patent Application Publication
(10) Pub. No.: US 2026/0238410 A1
(43) Pub. Date: Aug. 13, 2026

(54) PDSCH THROUGHPUT IMPROVEMENT BY PUCCH IRM/MRC AUTO SWITCHING

(71) Applicant: Telefonaktiebolaget LM Ericsson (publ), Stockholm (SE)

(72) Inventors: Qingchao LIU, Ottawa (CA); Xixian CHEN, Ottawa (CA); Pierre COLL, Gatineau (CA)

(73) Assignee: Telefonaktiebolaget LM Ericsson (publ), Stockholm (SE)

(21) Appl. No.: 19/155,950

(22) PCT Filed: Feb. 16, 2023
(86) PCT No.: PCT/IB2023/051423

§ 371 Date: Aug. 13, 2025

(51) Int. Cl. H04L 5/00; H04L 1/1812; H04W 72/21; H04W 76/28

(52) U.S. Cl. CPC H04L 5/0044; H04L 1/1812; H04W 72/21; H04W 76/28

(57) ABSTRACT

The present disclosure comprises improvements to Physical Downlink Shared Channel (PDSCH) throughput by switching between Maximum Ratio Combining (MRC) and Interference Rejection Combining (IRC) demodulation based on interference levels in a Physical Uplink Control Channel (PUCCH) transmission received from a wireless communication device. The base station can demodulate the PUCCH transmission using MRC if interference level is below a predefined interference level and IRC if it is above the predefined interference level. The base station can then decode the PUCCH transmission using either polar decoding or Reed-Muller decoding based on the number of information bits in the PUCCH transmission and determine an interference metric associated with the PUCCH transmission. Based on one or more of a Hybrid Automatic Repeat Request (HARQ) acknowledgment (ACK) or negative acknowledgement (NACK), DTX detection, and the interference metric, the base station can perform one of a variety of functions.

### TECHNICAL FIELD

The present disclosure relates to improving Physical Downlink Shared Channel (PDSCH) throughput by switching between Maximum Ratio Combining and Interference Rejection Combining demodulation based on interference levels.

### BACKGROUND

Hybrid Automatic Repeat Request (HARQ) is an essential component of Fifth Generation (5G) New Radio (NR). A New Radio Base Station (gNB) sends Downlink Control Information (DCI) on Physical Downlink Control Channel (PDCCH) which carries scheduling information for uplink and downlink. It provides a user equipment device (UE) with the necessary information for proper reception and decoding of the downlink data on Physical Downlink Shared Channel (PDSCH) as well as transmitting the uplink data and uplink control information (UCI) on Physical Uplink Shared Channel (PUSCH) or UCI on Physical Uplink Control Channel (PUCCH).

Link Adaptation (LA) is an important Radio Resource Management (RRM) function in wireless communication systems for reliable communication. The purpose of link adaptation is to determine the appropriate modulation and coding scheme (MCS) to maximize user throughput or data rate. In a typical system which utilizes HARQ, the task of LA is to determine the highest MCS for which the targeted operating point (e.g., block error rate (BLER) after certain number of HARQ transmissions) can be achieved. To perform link adaptation, information on the communication link quality is required. This may be obtained either from measurements at the transmitter or reports of Channel State Information (CSI) from receiver to transmitter. To achieve high throughput, LA may be performed in every transmission time interval (e.g., per slot).

As mentioned earlier, the downlink (DL) link quality can be determined from reported CSI from the wireless communication device. The methodology of evaluating link quality is not defined by Third Generation Partnership Project (3GPP) standards, however, and thus it varies from wireless communication device vendor to vendor. Some types of wireless communication devices may report optimistic CSI while other types of wireless communication devices may report pessimistic CSI. The CSI reported by wireless communication devices is typically mapped to a channel quality measure by the transmitter (for example signal to interference and noise ratio (SINR)).

To accommodate systematic errors in Channel Quality Indicator (CQI) reporting from the wireless communication device and to track faster changes in channel conditions, a PDSCH outer-loop adjustment is normally used to generate an outer-loop adjustment OL_ADJ which is added to the PDSCH SINR estimation based on the CQI report. The overall estimated SINR based on CQI and outer-loop adjustment is used in determining the MCS. The outer-loop adjustment is calculated based on the PDSCH transmission result, which is determined by gNB. The transmission result could be a success, or failure.

For each DL transmission, the HARQ feedback result transmitted on either PUCCH or PUSCH could be PDSCH acknowledgment (ACK), when the wireless communication device successfully decodes both PDCCH and PDSCH, and sends ACK to gNB;
PDSCH negative acknowledgement (NACK), when the wireless communication device successfully decodes PDCCH but fails to decode PDSCH and sends NACK to gNB;
DTX (Discontinuous Transmission), when the wireless communication device fails to decode PDCCH and does not send any feedback to gNB.

There are five different formats of PUCCH, and which one of them is used is determined by how many bits of information should be carried and how many symbols are assigned.

We have the following UCI encoders depending on the number of its information bits:
1 information bit-Table 5.3.3.1-1 of 38.212
2 information bits-Table 5.3.3.2-1 of 38.212
3-11 information bits-Section 5.3.3.3 R-M block encoder in 38.212
>=12 information bits-Section 5.3.1 Polar encoder in 38 212.

With DL Carrier Aggregation (CA) and Time Division Duplex (TDD) carrier components, the bundled DL HARQ feedback bits will be in the range of 3 to 35 bits, depending on the number of carrier components and each carrier's TDD patterns. Furthermore, the HARQ feedback from wireless communication device through gNB uplink (UL) channels (PUCCH and PUSCH) will be vital to dictating the PDSCH transmissions and their re-transmissions. Hence, the feedback decoding performance dramatically impacts the PDSCH throughput.

If there is no UL traffic, PUCCH format 3 is often used to carry the HARQ feedback. PUCCH format 3 decoding performance is thus key to the success of the PDSCH transmissions. If the decoding performance can be improved by 1 or 2 dBs, the cell coverage can be extended, and the feedback will be more reliable.

The conventional PUCCH receivers only support the IRC decoding method. However, Interference Rejection Combining (IRC) performs much worse than Maximum Ratio Combining (MRC) when there is no interference. The more the bits, the more significant the loss.

### SUMMARY

The present disclosure comprises a method and base station for improving Physical Downlink Shared Channel (PDSCH) throughput by switching between Maximum Ratio Combining (MRC) and Interference Rejection Combining (IRC) demodulation based on detected interference levels in a Physical Uplink Control Channel (PUCCH) transmission received from a wireless communication device (e.g., a User Equipment device (UE)). If the interference level is below some predefined interference level, the base station (e.g., a gNB) can demodulate the PUCCH transmission using an MRC demodulation technique, while if the interference level is above the predefined interference level, the base station can demodulate the PUCCH transmission using an IRC demodulation technique. The base station can then decode the PUCCH transmission using either polar decoding or Reed-Muller decoding based on the number of information bits in the PUCCH transmission, and based on the decoding technique, determine an interference metric associated with the PUCCH transmission. Based on one or more of a Hybrid Automatic Repeat Request (HARQ) acknowledgment (ACK) or negative acknowledgement (NACK), and the interference metric and its relationship to a discontinuous transmission (DTX) threshold, the base station can perform one of a variety of functions, including retransmitting a previous PDSCH transmission, transmit a redundant PDSCH transmission, or perform a PDSCH or Physical Downlink Control Channel (PDCCH) outer loop adjustment, or end the process.

In an embodiment, a method can be provided that is performed by a base station for improving PDSCH throughput by switching between MRC and IRC decoding based on interference. The method can include receiving a PUCCH transmission from a wireless communication device over a wireless channel from the wireless communication device to the base station. The method can include determining a level of interference present on the wireless channel from the wireless communication device to the base station. The method can include demodulating the PUCCH transmission using an MRC demodulation technique if the level of interference on the wireless channel is below a predefined interference level. The method can include demodulating the PUCCH transmission using an IRC demodulation technique if the level of interference on the wireless channel is above the predefined interference level.

In an embodiment, base station can be provided that is configured to improve PDSCH throughput by switching between MRC and IRC decoding based on interference. The base station can include a radio interface and processing circuitry configured to receive a PUCCH transmission from a wireless communication device over a wireless channel from the wireless communication device to the base station. The processing circuitry can be further configured to determine a level of interference present on the wireless channel from the wireless communication device to the base station. The processing circuitry can be further configured to demodulate the PUCCH transmission using an MRC demodulation technique if the level of interference on the wireless channel is below a predefined interference level. The processing circuitry can be further configured to demodulate the PUCCH transmission using an IRC demodulation technique if the level of interference on the wireless channel is above the predefined interference level.

In an embodiment, a non-transitory computer-readable medium can be provided that includes instructions stored thereon, that when implemented by a processor perform operations for improving PDSCH throughput by switching between MRC and IRC decoding based on interference. The operations can include receiving a PUCCH transmission from a wireless communication device over a wireless channel from the wireless communication device to the base station. The operations can include determining a level of interference present on the wireless channel from the wireless communication device to the base station. The operations can include demodulating the PUCCH transmission using an MRC demodulation technique if the level of interference on the wireless channel is below a predefined interference level. The operations can include demodulating the PUCCH transmission using an IRC demodulation technique if the level of interference on the wireless channel is above the predefined interference level.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system according to some embodiments of the present disclosure;

FIG. 2 illustrates an exemplary receive chain of a base station device according to one or more embodiments of the present disclosure;

FIG. 3 illustrates a flowchart of a method for improving Physical Downlink Shared Channel (PDSCH) throughput according to one or more embodiments of the present disclosure;

FIG. 4A is a table depicting exemplary Maximum Ratio Combining (MRC) and Interference Rejection Combining (IRC) auto-switching thresholds according to one or more embodiments of the present disclosure;

FIG. 4B is a table depicting exemplary Discontinuous Transmission metric thresholds for a Physical Uplink Control Channel (PUCCH) transmission having between 3 and 11 information bits according to one or more embodiments of the present disclosure;

FIG. 4C is a table depicting exemplary Discontinuous Transmission (DTX) metric thresholds for a PUCCH transmission having 12 or more information bits according to one or more embodiments of the present disclosure;

FIG. 5 is a schematic block diagram of a radio access node according to some embodiments of the present disclosure;

FIG. 6 is a schematic block diagram that illustrates a virtualized embodiment of the radio access node of FIG. 5 according to some embodiments of the present disclosure; and

FIG. 7 is a schematic block diagram of the radio access node of FIG. 5 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Wireless Communication Device: A wireless communication device may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

The present disclosure comprises a method and base station for improving Physical Downlink Shared Channel (PDSCH) throughput by switching between Maximum Ratio Combining (MRC) and Interference Rejection Combining (IRC) demodulation based on detected interference levels in a Physical Uplink Control Channel (PUCCH) transmission received from a wireless communication device (e.g., a UE). If the interference level is below some predefined interference level, the base station (e.g., a gNB) can demodulate the PUCCH transmission using an MRC demodulation technique, while if the interference level is above the predefined interference level, the base station can demodulate the PUCCH transmission using an IRC demodulation technique. The base station can then decode the PUCCH transmission using either polar decoding or Reed-Muller decoding based on the number of information bits in the PUCCH transmission, and based on the decoding technique, determine an interference metric associated with the PUCCH transmission. Based on one or more of a Hybrid Automatic Repeat Request (HARQ) acknowledgment (ACK) or negative acknowledgement (NACK), and the interference metric and its relationship to a discontinuous transmission (DTX) threshold, the base station can perform one of a variety of functions, including retransmitting a previous PDSCH transmission, transmit a redundant PDSCH transmission, or perform a PDSCH or Physical Downlink Control Channel (PDCCH) outer loop adjustment, or end the process.

Some of the advantages provided by the techniques described here, include improving the throughput of PDSCH transmissions. For the cases with all the ranges of Downlink (DL) HARQ feedback bits carried on PUCCH format 3, about 2 dB SINR improvement is achieved at 1% Block Error Rate (BLER) target. The higher the number of feedback bits, the more significant the improvement. The algorithms disclosed herein can guarantee that the ACK false rate will be lower than 1%, missed ACK rate would be lower than 1%, NACK to ACK lower than 0.1%, BLER lower than 1%, improvements that meet the 3GPP standard. Another advantage is improved Link Adaptation (LA) for PDSCH and Physical Downlink Control Channel (PDCCH) transmissions, as well as substantial improvements to overall DL cell throughput.

The PUCCH receiver can use either MRC or IRC demodulation techniques. But IRC will perform better than MRC when there is interference, while MRC will perform better if interference is absent. Therefore, detection of the interference coupled with IRC and MRC auto-switching will utilize the benefits of both algorithms.

The interference detection is based on the noise covariance Q matrix of the channel. The IRC and MRC switching can be determined by a predefined threshold or interference level. In an embodiment, when MRC is used, the off-diagonal elements of the noise covariance are set to zero for demodulation. The threshold is determined through simulations based on the number of receiver branches.

The DTX detection algorithm is based on the Signal to Interference plus Noise Ratio (SINR) value estimated at the receiver with a Polar decoder (for times when the PUCCH transmission has >=12 information bits) and is based on a decoding metric with small block decoder (e.g., Reed-Muller decoder) (for times when the PUCCH transmission has 3 to 11 information bits). The DTX detection threshold is determined through simulations based on the number of bits to be decoded and the number of receiver branches. The thresholds for IRC and MRC are different. DTX will be declared if the DTX threshold is not met.

If the receiver decoding result is not DTX by checking the DTX thresholds, the Polar decoding passes Cyclic Redundancy Check (CRC) check or small block decoder finishes without CRC check, it means that the wireless communication device 112 had successfully decoded the PDCCH, and the gNB can use the decoding result for further processing. The decoding result can be ACK, NACK or DTX, or UNKOWN. UNKNOWN is detected when the HARQ bundle (many HARQ bits) is not detected as DTX, but with some NACKs; these NACKs are classified as “UNKNOWN”. The decoding result can also be used to perform the outer-loop adjustment of the PDSCH SINR adjustment (ACK and NACK) and PDCCH SINR adjustment (DTX or non-DTX).

Although the above algorithms are developed for PUCCH format 3 HARQ bit decoding, they can also be applied to other PUCCH formats, such as formats 1, 2, 4, etc. The algorithms disclosed in this present disclosure can also be implemented in Cloud RAN and O-RAN and also in LTE eNB or for small PUSCH.

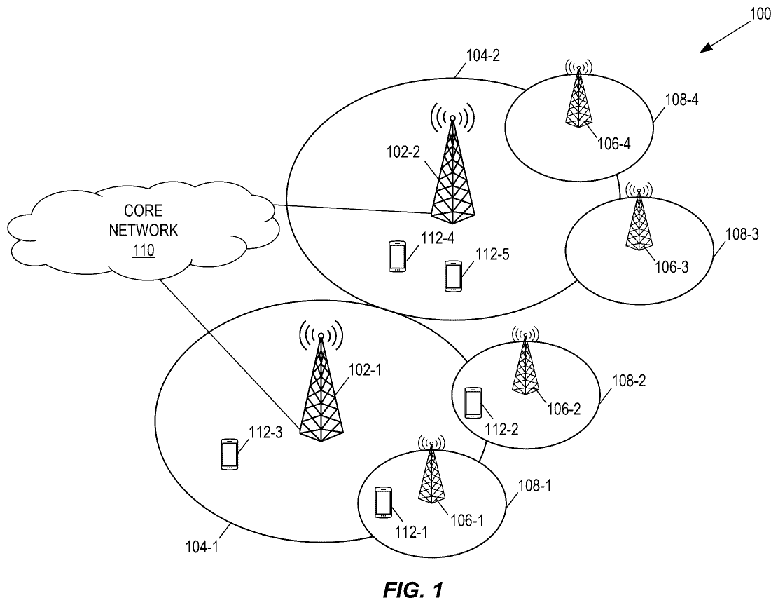

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC). In this example, the RAN includes base stations 102-1 and 102-2, which in the 5GS include NR base stations (gNBs) and optionally next generation eNBs (ng-eNBs) (e.g., LTE RAN nodes connected to the 5GC), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs, but the present disclosure is not limited thereto.

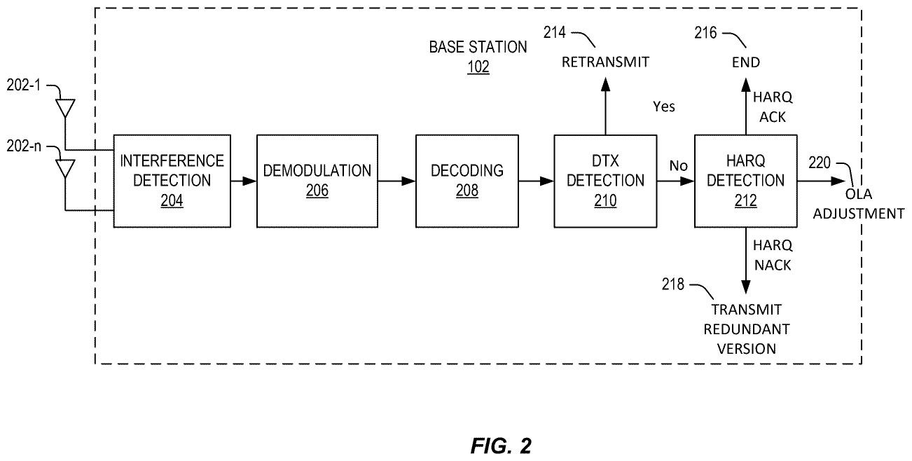

FIG. 2 illustrates an exemplary receive chain of a base station device 102 according to one or more embodiments of the present disclosure.

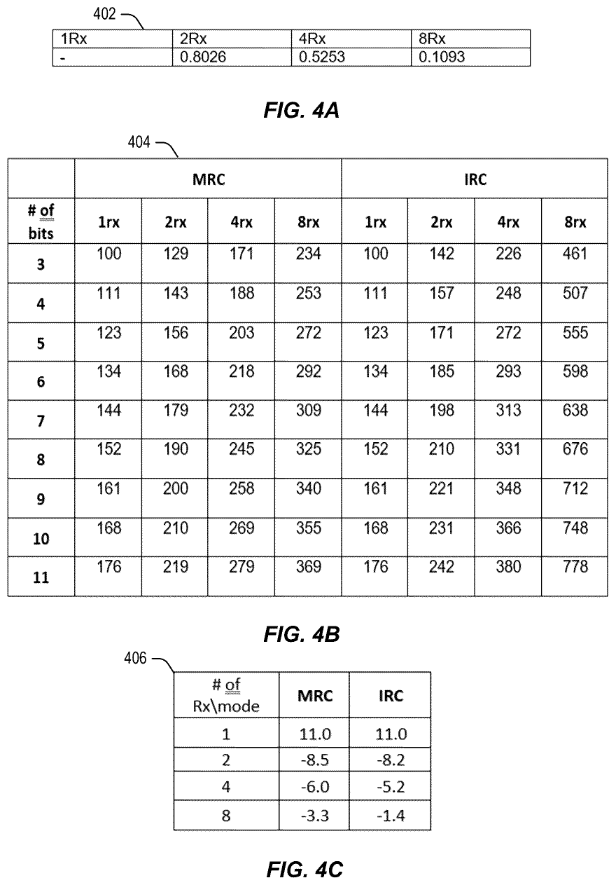

The base station device 102 can receive a PUCCH transmission from wireless communication device 112, at one or more of antennas 202-1 to 202-n. Interference detection 204 can be performed on the PUCCH transmission in order to determine whether to use MRC or IRC demodulation. The interference can be detected based on the noise covariance Q matrix of the channel. The following equation is used to quantify the interference:

$$β = \frac{det ( Q )}{{\sum }_{a = 0}^{N a - 1} Q ( a , a )} \qquad Eqn . 1$$

Where a is the antenna index, Na is the total number of antennas, det (Q) is the determinant of the noise covariance matrix. Then, the base station 102 can determine whether to use IRC or MRC at the demodulation 206 stage, based on the interference level. For example, if β≤Tₜₕᵣ IRC is used, otherwise MRC is used. It should be appreciated that β is inversely proportional to the interference level. Therefore, a low β corresponds to a higher interference than a high β. In When MRC is used, the off-diagonal elements of the noise covariance are set to zero. Tₜₕᵣ depicted in FIG. 4A is a table determined through simulations. The threshold at which IRC or MRC is selected is determined through simulations. In the table in FIG. 4A for example, table 402 shows the different thresholds based on the number of receivers. For example, for a single receiver (e.g., antenna 202), MRC can be used, while the different thresholds are shown for 2, 4, or 8 receivers.

After the received PUCCH transmission is demodulated at 206, the base station 102 can decode the PUCCH transmission at 208 using either polar decoding or small-block decoding (e.g., Reed-Muller) decoding based on the number of information bits in the PUCCH transmission. If the PUCCH transmission has between 3 and 11 (inclusive) information bits, the base station 102 will decode with the Reed-Muller decoding technique, and if there are 12 or more information bits, the base station 102 will decode the PUCCH transmission with a polar decoder.

DTX detection can be performed by the base station 102 at 210, where the DTX metric is determined based on whether polar decoding or Reed-Muller decoding was used to decode the PUCCH transmission, with different calculation techniques being performed based on the decoder type. If a DTX metric is not met (e.g., the estimated SINR is below an SINR threshold for polar decoding, or a decoding metric doesn't meet a decoding threshold for Reed-Muller decoding), DTX will be declared and the base station 214 will retransmit the previous PDCCH transmission at 214 since it is inferred that the wireless communication device 112 was not able to decode the PDCCH. Table 404 in FIG. 4B shows the decoding thresholds in terms of a DTX metric for Reed-Muller decoding for both MRC and IRC decoding, number of receivers, and number of bits. Table 406 in FIG. 4C shows the SINR threshold for polar decoding when there are 12 or more information bits and based on the number of receivers and whether MRC or IRC demodulation was performed.

For the Reed-Muller decoding, if dₘₐₓ<DTXₜₕᵣ DTX=TRUE. Otherwise, DTX=FALSE, where dₘₐₓ is the best decoding metric, and example DTX thresholds are shown in table 404.

For polar decoding (e.g., there are 12 or more information bits) if Receive SINR<DTXₜₕₓ DTX=TRUE. Otherwise DTX=FALSE. Table 406 shows one example DTX thresholds for Polar decoder. They are common to bits range>=12 bits.

If frequency hopping is used especially for non-flat channels, the IRC/MRC detection will be on a per-hop basis, and interpolation of DTX threshold tables will be used if one hop is IRC and another hop is MRC.

$$D T {X}_{thr} = ( α * {DTX}_{{irc}_{t h r}} + ( 1 - α ) * {DTX}_{m r {c}_{t h r}} ) / 10 \qquad Eqn : 2$$

Where 5≤α≤10, DTX_{irc}_{ₜₕᵣ} and DTX_{mrc}_{ₜₕᵣ} are corresponding IRC and MRC DTX thresholds. When there is no frequency hopping configured, there is only one hop for all symbols (one noise covariance Q), the DTX detection will be either using IRC DTX threshold or MRC DTX threshold, α will be 1 or 0 corresponding to DTX_{irc}_{ₜₕᵣ} and DTX_{mrc}_{ₜₕᵣ}, the switching detection will detect this scenario and pass on the information for DTX detection. DTX_{irc}_{ₜₕᵣ} and DTX_{mrc}_{ₜₕᵣ} are determined through simulations.

The base station 102 can also perform HARQ detection at 212, and based on whether there is a HARQ ACK or NACK, the base station 102 can either end the HARQ process at 216 (for an ACK), or transmit a new redundant version of the PDCCH at 218 (for a NACK). The base station device 102 can also perform an outerloop adjustment for a future PDSCH transmission or a PDCCH transmission based on the HARQ ACK or NACK and based on the DTX metric measured at 210. For example, the PDSCH transmission outer loop adjustment is based on whether a HARQ ACK or NACK is detected, and the PDCCH transmission outer loop adjustment is based on whether DTX is detected or not.

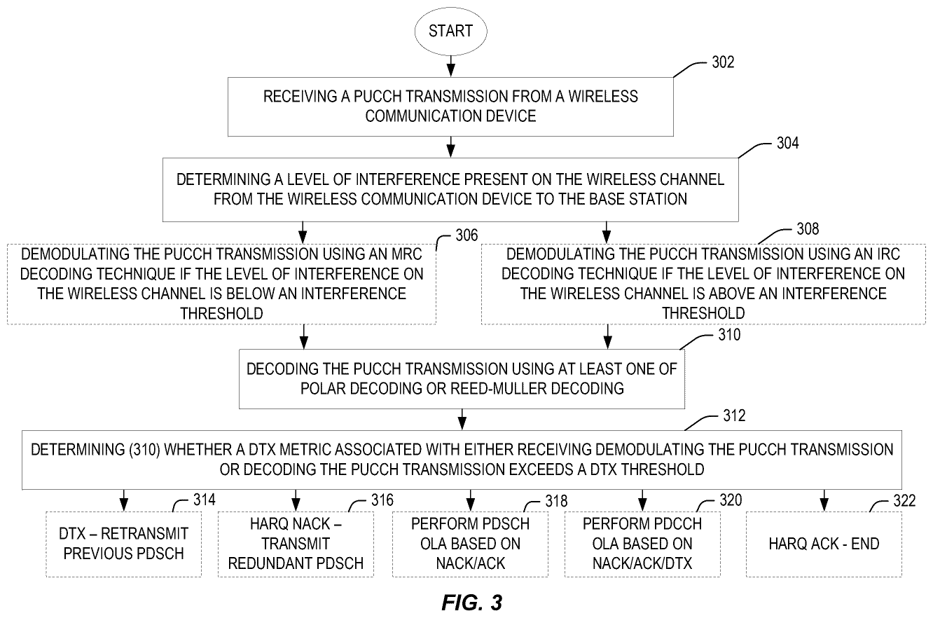

Turning now to FIG. 3, a flowchart of a method for improving PDSCH throughput according to one or more embodiments of the present disclosure is illustrated.

The flowchart can begin at step 302 where the method includes receiving a PUCCH transmission from a wireless communication device 112 over a wireless channel from the wireless communication device 112 to the base station 102.

At step 304, the method includes determining a level of interference present on the wireless channel from the wireless communication device 112 to the base station 102. In an embodiment, the level of interference is defined by an interference metric, and the PUCCH transmission is demodulated using the MRC technique if the interference metric is above an interference metric threshold, and the PUCCH transmission is demodulated using the IRC technique if the interference metric is below the interference metric threshold. The level of interference is based on a noise covariance matrix of the wireless channel from the wireless communication device 112 to the base station 102.

At step 306 and 308, the PUCCH transmission can be demodulated, either at step 306 which includes demodulating the PUCCH transmission using an MRC demodulation technique if the level of interference on the wireless channel is below a predefined interference level, or at step 308 which includes demodulating the PUCCH transmission using an IRC demodulation technique if the level of interference on the wireless channel is above the predefined interference level.

At 310, the method includes decoding the PUCCH transmission using at least one of polar decoding or Reed-Muller decoding.

At 312, the method includes determining whether a DTX metric associated with either demodulating the PUCCH transmission or decoding the PUCCH transmission exceeds a DTX threshold. The DTX threshold is a function of whether the MRC decoding technique or the IRC decoding technique is used for demodulating the PUCCH transmission. The DTX threshold can also be a function of number of HARQ bits comprised in the PUCCH transmission and a number of receive antennas used by the base station for receiving the PUCCH transmission.

If the DTX metric is not met, then the base station 102 can declare DTX, and at step 314 retransmit the previous PDSCH. When the PUCCH decoding result is classified as DTX, it means that the wireless communication device 112 failed to decode the PDCCH and didn't send the HARQ feedback to the gNB. As a result, the base station device 102 shall retransmit the same data packets to the wireless communication device 112 with the same redundant version

If there is a HARQ NACK, the base station device 102 can transmit a different, redundant version of the PDSCH at step 316. If the decoding result is classified as unknown, the base station device 102 can't determine if the wireless communication device 112 sent the HARQ NACK or DTX when the HARQ bundle size is bigger than 1. To be safe, base station device 102 can treat them as DTXs and retransmit the same data packets to the wireless communication device 112 with same redundant version.

If the decoding result is classified as successful, it means that the wireless communication device 112 successfully decoded the PDCCH and sent its corresponding HARQ feedback. Based on the decoding result, base station device 102 will perform the following process. If the HARQ feedback is NACK, its corresponding data packet will be retransmitted with a different redundant version at step 316. If it is ACK, the gNB knows that the wireless communication device 112 successfully received the data packet and will remove it from the DL transmit buffer and corresponding HARQ process shall be terminated at step 322.

At steps, 318 and 320, the base station device 102 can also perform PDSCH outer-loop adjustment or PDCCH outer-loop adjustment respectively.

For PDSCH outer-loop adjustment at step 318, if the previous transmission's HARQ feedback is ACK or NACK, it means that the wireless communication device 112 has successfully decoded the PDCCH. If the decoded bit is ACK, the PDSCH SINR is increased by an amount defined as UP_STEP. So, the SINR adjustment will be:

$$OL\_ADJ += UP\_STEP$$

If the decoded bit is NACK, the PDSCH SINR is decreased by an amount defined as DOWN_STEP. So, the SINR adjustment will be:

$$OL\_ADJ -= DOWN\_STEP$$

If the previous transmission HARQ feedback is classified as either a DTX or “unknown”, no action is required.

The ratio of the UP_STEP and DOWN_STEP is determined based on the desired BLER target in percentage (or the PDSCH transmission failure rate):

$$DOWN\_STEP / UP\_STEP = 100 / BLER\_TARGET - 1$$

The DOWN_STEP value can be tuned to have the desired outer-loop convergence speed. BLER_TARGET can be pre-determined, e.g., 10%.

For PDCCH outer-loop adjustment at step 318, if DTX is not detected (ACK or NACK), it means that the wireless communication device 112 has successfully decoded the PDCCH. The PDSCH SINR is increased by an amount defined as UP_STEP. So, the SINR adjustment will be:

$$OL\_ADJ += UP\_STEP$$

If DTX is detected, the PDSCH SINR is decreased by an amount defined as DOWN_STEP. So, the SINR adjustment will be:

$$OL\_ADJ -= DOWN\_STEP$$

If HARQ feedback cannot differentiate DTX and NACK, either there is no action for OLA or do a fraction of DOWN_STEP adjustment, i.e. α

$$OL\_ADJ -= α * PDCCH\_DOWN \_STEP$$

The ratio of the UP_STEP and DOWN_STEP can be tuned based some different target criteria. One example is:

$$PDCCH\_DOWN \_STEP / PDCH\_UP \_STEP = 100 / BLER\_TARGET - 1$$

BLER_TARGET can be pre-determined, e.g., 1%.

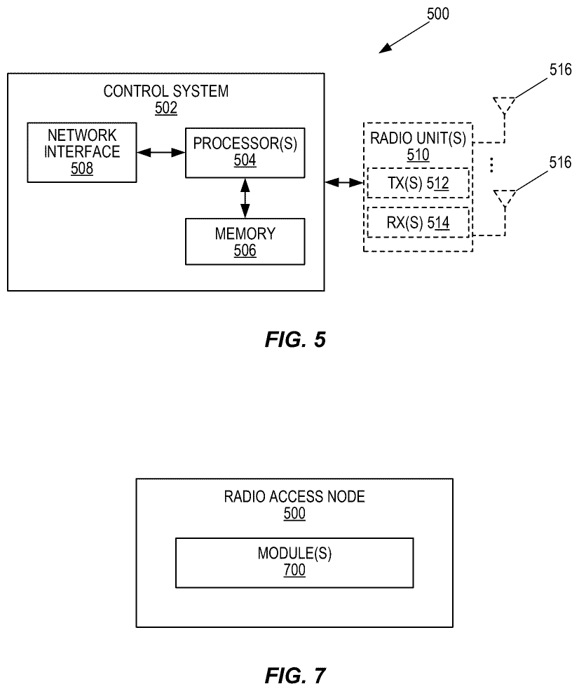

FIG. 5 is a schematic block diagram of a radio access node 500 according to some embodiments of the present disclosure. Optional features are represented by dashed boxes. The radio access node 500 may be, for example, a base station 102 or 106 or a network node that implements all or part of the functionality of the base station 102 or gNB described herein. As illustrated, the radio access node 500 includes a control system 502 that includes one or more processors 504 (e.g., Central Processing Units (CPUs), Application Specific Integrated Circuits (ASICs), Field Programmable Gate Arrays (FPGAs), and/or the like), memory 506, and a network interface 508. The one or more processors 504 are also referred to herein as processing circuitry. In addition, the radio access node 500 may include one or more radio units 510 that each includes one or more transmitters 512 and one or more receivers 514 coupled to one or more antennas 516. The radio units 510 may be referred to or be part of radio interface circuitry. In some embodiments, the radio unit(s) 510 is external to the control system 502 and connected to the control system 502 via, e.g., a wired connection (e.g., an optical cable). However, in some other embodiments, the radio unit(s) 510 and potentially the antenna(s) 516 are integrated together with the control system 502. The one or more processors 504 operate to provide one or more functions of a radio access node 500 as described herein. In some embodiments, the function(s) are implemented in software that is stored, e.g., in the memory 506 and executed by the one or more processors 504.

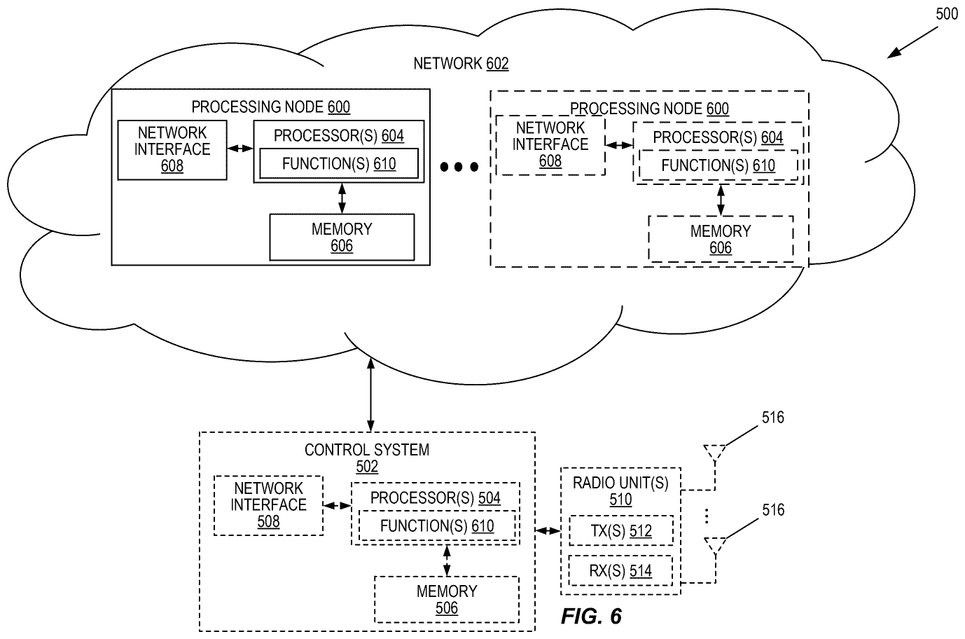

FIG. 6 is a schematic block diagram that illustrates a virtualized embodiment of the radio access node 500 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 500 in which at least a portion of the functionality of the radio access node 500 is implemented as a virtual component(s) (e.g., via a virtual machine(s) executing on a physical processing node(s) in a network(s)). As illustrated, in this example, the radio access node 500 may include the control system 502 and/or the one or more radio units 510, as described above. The control system 502 may be connected to the radio unit(s) 510 via, for example, an optical cable or the like. The radio access node 500 includes one or more processing nodes 600 coupled to or included as part of a network(s) 602. If present, the control system 502 or the radio unit(s) are connected to the processing node(s) 600 via the network 602. Each processing node 600 includes one or more processors 604 (e.g., CPUs, ASICs, FPGAs, and/or the like), memory 606, and a network interface 608.

In this example, functions 610 of the radio access node 500 described herein are implemented at the one or more processing nodes 600 or distributed across the one or more processing nodes 600 and the control system 502 and/or the radio unit(s) 510 in any desired manner. In some particular embodiments, some or all of the functions 610 of the radio access node 500 described herein are implemented as virtual components executed by one or more virtual machines implemented in a virtual environment(s) hosted by the processing node(s) 600. As will be appreciated by one of ordinary skill in the art, additional signaling or communication between the processing node(s) 600 and the control system 502 is used in order to carry out at least some of the desired functions 610. Notably, in some embodiments, the control system 502 may not be included, in which case the radio unit(s) 510 communicate directly with the processing node(s) 600 via an appropriate network interface(s).

In some embodiments, a computer program including instructions which, when executed by at least one processor, causes the at least one processor to carry out the functionality of radio access node 500 or a node (e.g., a processing node 600) implementing one or more of the functions 610 of the radio access node 500 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 7 is a schematic block diagram of the radio access node 500 according to some other embodiments of the present disclosure. The radio access node 500 includes one or more modules 700, each of which is implemented in software. The module(s) 700 provide the functionality of the radio access node 500 described herein. This discussion is equally applicable to the processing node 600 of FIG. 6 where the modules 700 may be implemented at one of the processing nodes 600 or distributed across multiple processing nodes 600 and/or distributed across the processing node(s) 600 and the control system 502.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
ACK Acknowledgment
AN Access Network
ASIC Application Specific Integrated Circuit
BLER Block Error Rate
CA Carrier Aggregation
CPU Central Processing Unit
CQI Channel Quality Indicator
CRC Cyclic Redundancy Check
CSI Channel State Information
DCI Downlink Control Information
DL Downlink
DSP Digital Signal Processor
DTX Discontinuous Transmission
eNB Enhanced or Evolved Node B
FPGA Field Programmable Gate Array
gNB New Radio Base Station
gNB-DU New Radio Base Station Distributed Unit
HARQ Hybrid Automatic Repeat Request
IoT Internet of Things
IRC Interference Rejection Combining
LA Link Adaptation
LTE Long Term Evolution
MCS Modulation and Coding Scheme
MRC Maximum Ratio Combining
MTC Machine Type Communication
NACK Negative Acknowledgement
NR New Radio
PC Personal Computer
PDCCH Physical Downlink Control Channel
PDSCH Physical Downlink Shared Channel
PUCCH Physical Uplink Control Channel
PUSCH Physical Uplink Shared Channel
RAM Random Access Memory
RAN Radio Access Network
ROM Read Only Memory.
RRH Remote Radio Head
RRM Radio Resource Management
SINR Signal to Interference and Noise Ratio
TDD Time Division Duplex
UCI Uplink Control Information
UE User Equipment
UL Uplink

Those skilled in the art will recognize improvements and modifications to the embodiments of the present disclosure. All such improvements and modifications are considered within the scope of the concepts disclosed herein.

1. A method performed by a base station for improving Physical Downlink Shared Channel, PDSCH, throughput by switching between Maximum Ratio Combining, MRC, and Interference Rejection Combining, IRC, decoding based on interference, the method comprising:
receiving a Physical Uplink Control Channel, PUCCH, transmission from a wireless communication device over a wireless channel from the wireless communication device to the base station;
determining a level of interference present on the wireless channel from the wireless communication device to the base station;
demodulating the PUCCH transmission using an MRC demodulation technique if the level of interference on the wireless channel is below a predefined interference level; and
demodulating the PUCCH transmission using an IRC demodulation technique if the level of interference on the wireless channel is above the predefined interference level.

2. The method of claim 1, wherein the level of interference is defined by an interference metric, and the PUCCH transmission is demodulated using the MRC technique if the interference metric is above an interference metric threshold, and the PUCCH transmission is demodulated using the IRC technique if the interference metric is below the interference metric threshold.

3. The method of claim 2, wherein the interference metric is based on a noise covariance matrix of the wireless channel from the wireless communication device to the base station.

4. The method of claim 1, further comprising:
decoding the PUCCH transmission using at least one of polar decoding or Reed-Muller decoding;
determining whether a DTX metric associated with either demodulating the PUCCH transmission or decoding the PUCCH transmission exceeds a DTX threshold; and
in response to the DTX metric being below the DTX threshold, retransmitting a previous PDSCH transmission to the wireless communication device.

5. The method of claim 4, wherein the DTX threshold is a function of whether the MRC decoding technique or the IRC decoding technique is used for demodulating the PUCCH transmission.

6. The method of claim 5, wherein the DTX threshold is further a function of number of Hybrid Automatic Repeat Request, HARQ, bits comprised in the PUCCH transmission.

7. The method of claim 5, wherein the DTX threshold is further a function of a number of receive antennas used by the base station for receiving the PUCCH transmission.

8. The method of claim 5, wherein the DTX metric associated with either receiving the PUCCH transmission or decoding the PUCCH transmission is a decoding metric associated with a result of decoding the PUCCH transmission.

9. The method of claim 5, wherein the DTX metric associated with either decoding the PUCCH transmission or demodulating the PUCCH transmission Signal to Interference plus Noise Ratio, SINR, of the PUCCH transmission.

10. The method of claim 5, wherein in response to a number of Hybrid Automatic Repeat Request, HARQ, bits comprised in the PUCCH transmission being 12 or more, the DTX metric is a Signal to Interference and Noise Ratio, SINR, of the PUCCH transmission, and the DTX threshold is a SINR threshold based on both a number of receive antennas and whether the demodulating of the PUCCH transmission used the MRC decoding technique or the IRC decoding technique.

11. The method of claim 5, wherein in response to the number of Hybrid Automatic Repeat Request, HARQ, bits in the demodulated PUCCH transmission being between greater than 2 and less than 12, the DTX threshold is a decoding metric based on the number of HARQ bits, a number of receive antennas, and whether the demodulating of the PUCCH transmission used the MRC decoding technique or the IRC decoding technique.

12. The method of claim 1, wherein the PUCCH transmission comprises at least one of a Hybrid Automatic Repeat Request, HARQ, Acknowledgement, ACK, or Negative ACK, NACK.

13. The method of claim 12, further comprising:
performing a Physical Downlink Shared Channel, PDSCH, outer-loop adjustment based on the at least one of the HARQ ACK or NACK; and
performing a PDCCH outer-loop adjustment based on at least one of the HARQ ACK, HARQ NACK, or the DTX metric.

14. The method of claim 12, further comprising
in response to the HARQ ACK, ending a HARQ process; or
in response to the HARQ NACK, retransmitting a different new redundant version of the previous PDSCH transmission.

15. The method of claim 1, wherein demodulating the PUCCH transmission using the MRC decoding technique comprises setting off-diagonal elements of a noise covariance matrix for the wireless channel to zero and using it for the demodulation process.

16. The method of claim 2, wherein in response to receiving the PUCCH transmission via frequency hopping, the steps of determining the interference metric, decoding the PUCCH transmission using the MRC decoding technique if the interference metric is indicative of the level of interference present on the wireless channel being above the predefined interference level, and decoding the PUCCH transmission using IRC decoding technique if the interference metric is indicative of the level of interference present on the wireless channel being below the predefined interference level are performed on a per-hop basis.

17. The method of claim 16, wherein determining whether the DTX metric exceeds the DTX threshold further comprises:
interpolating DTX threshold results in response to one hop being demodulated using the MRC decoding technique and another hop being demodulated using the IRC decoding technique.

18. A base station configured to improve Physical Downlink Shared Channel, PDSCH, throughput by switching between Maximum Ratio Combining, MRC, and Interference Rejection Combining, IRC, demodulation based on interference, the base station comprising a radio interface and processing circuitry configured to:
receive a Physical Uplink Control Channel, PUCCH, transmission from a wireless communication device over a wireless channel from the wireless communication device to the base station;
determine a level of interference present on the wireless channel from the wireless communication device to the base station;
demodulate the PUCCH transmission using an MRC decoding technique if the level of interference on the wireless channel is below a predefined interference level; and
demodulate the PUCCH transmission using an IRC decoding technique if the level of interference on the wireless channel is above the predefined interference level.

19-34. (canceled)

35. A non-transitory computer-readable medium comprising instructions stored thereon, that when implemented by a processor perform operations for improving Physical Downlink Shared Channel, PDSCH, throughput by switching between Maximum Ratio Combining, MRC, and Interference Rejection Combining, IRC, decoding based on interference, the operations comprising:
receiving a Physical Uplink Control Channel, PUCCH, transmission from a wireless communication device over a wireless channel from the wireless communication device to the base station;
determining a level of interference present on the wireless channel from the wireless communication device to the base station;
demodulating the PUCCH transmission using an MRC decoding technique if the level of interference on the wireless channel is below a predefined interference level; and
demodulating the PUCCH transmission using an IRC decoding technique if the level of interference on the wireless channel is above the predefined interference level.
